(19) United States
(12) Patent Application Publication
(10) Pub. No.: US 2011/0254424 A1
(43) Pub. Date: Oct. 20, 2011

(54) ALARM LIGHT DEVICE HAVING LAMPS EMBEDDED IN OPENINGS

(75) Inventor: TZU-FAN KUO, TAINAN (TW)

(73) Assignee: LUMINOUS STAR TECHNOLOGY LTD., TAINAN (TW)

(21) Appl. No.: 12/763,428

(22) Filed: Apr. 20, 2010

(51) Int. Cl. H01J 61/52; H01J 5/48

(52) U.S. Cl. 313/46; 313/318.01

(57) ABSTRACT

This invention relates to an alarm light device having lamps embedded in openings, in which a main lamp portion is coupled with two side lamp portions together at both sides thereof. The main lamp portion and the side light portions all have channel-openings for embedding a plurality of lamp modules. Each lamp module is covered by a corresponding outer-cover which is then fastened to the base plate of each lamp module. In this manner, as the lamps are directly embedded, they can be directly assembled or disassembled such that great convenience in conducting the replacement of lamp can be achieved.

### BACKGROUND OF THE INVENTION

1. Field of the Invention

The present invention relates to an alarm light device having lamps embedded in openings, more particularly to an assembly structure of lamp installed on vehicle for alarming purpose, in which lamps can be directly assembled or disassembled so as to achieve great convenience in conducting replacement of lamp.

2. Brief Description of the Prior Art

In view of the popularity of transportation means nowadays, a large numbers of vehicles are going and coming on the roads. In order to improve traffic safety and reduce the occurrence of traffic accidents, alarm light is usually installed on the roof outside of public office vehicles (such as police vehicles, ambulance, engineering car) so as to provide a warning indication to the opposite incoming cars or the rear vehicles and to draw attention of personnel inside the cars or in the periphery, such that suitable driving distance can be maintained to avoid the problem of insufficiency in effective braking distance resulted from short driving distance. Alternatively, the alarm light also can be used for breakdown demonstration to the vehicles or personnel in the periphery so as to enhance driving safety.

A typical alarm light is constructed as an alarm light having waterproof structure disclosed in Taiwanese New Utility Model No. M367307, comprising a lamp seat, a cover body, waterproof tape stripes and waterproof gaskets, a plurality of light-emitting modules being provided on the periphery outside of the lamp seat, and the exterior of the lamp seat being encapsulated by the cover body which is formed by lid plates, side covers and fixed outer-covers, characterized in that said lid plates of rectangular shape are respectively located on the upper and the lower sides of said lamp seat, said side covers being movably snap-fastened on both long-sides of each lid plate, said fixed outer-covers being respectively fastened on both short-sides of each lid plate, the long-side of said lid plates being provided with grooves for inserting said waterproof tape stripes and male snap-fit blocks extending from the openings of the grooves, said grooves and said male snap-fit blocks being respectively mated with the hooks extending from both sides of the side covers and the female snap-fit grooves so as to press said waterproof tape stripes tightly, fastening members being screwed in the tap holes provided on the short-sides of said lid plates after penetrating through the holes and the through holes respectively provided on said fixed outer-covers and on the surface of said waterproof tape stripes so that said waterproof tape stripes are located between said fixed outer-covers and said lid covers, and the cover body can encapsulate tightly on the outside of said lamp seat.

The light-emitting modules are embedded one by one on the rail provided on the lamp seat and then the waterproof gaskets, waterproof tape stripes and cover body are fitted in this order over the lamp seat. Hence, when any one light-emitting module is out of order and needs to be replaced, the cover body in tight fitting should be dismantled first, and then the light-emitting modules are taken out one by one. After the replacement of damaged light-emitting module is finished, the other undamaged light-emitting modules are again embedded one by one. Hence, the assembly and disassembly of the alarm light is very complicated and difficult. Besides, due to the structure of the cover body covering the lamp seat, the thickness of the lamp seat should be enlarged so as to provide enough dimensions for fixing the cover body. Hence, the volume of the alarm light becomes very large. Furthermore, as the cover body is of externally-covered type, mist or steam is liable to permeate such that fog is produced on the surface of the lamp of inside of the lamp cover. This might affect the illumination efficiency of the alarm light.

In an effort to overcome the aforementioned deficiency, the inventor of the present invention proposes an alarm light device having lamps embedded in openings based on his proficient experience and knowledge in R&D and manufacturing in relevant field and endless endeavor, so as to achieve object of better practical value.

### SUMMARY OF INVENTION

The main object of the alarm light device having lamps embedded in openings of the present invention is to improve the shortcomings of difficulty in assembly and disassembly of prior art, and to achieve the effect of replacing lamp efficiently by means of direct assembly and disassembly.

The above object and effect of the alarm light device having lamps embedded in openings of the present invention can be achieved by the following technology.

According to the present invention, an alarm light device having lamps embedded in openings is provided, in which a main lamp portion is coupled with two side lamp portions at both sides thereof, the main lamp portion and the side lamp portions all having channeled openings for embedding a plurality of lamp modules therein, each lamp module being covered by a corresponding outer-cover which is then fastened to the base plate of each lamp module. In this manner, as the lamp modules are directly embedded, they can be directly assembled or disassembled such that great convenience in conducting the replacement of lamp can be achieved.

### BRIEF DESCRIPTION OF THE DRAWINGS

FIG. 1 is a perspective schematic view showing the assembly of the alarm light device having lamps embedded in openings of the present invention.

FIG. 2 is a perspective exploded view showing the alarm light device having lamps embedded in openings of the present invention.

FIG. 3 is a perspective exploded schematic view showing the lamp module of the present invention.

FIG. 4 is a sectional schematic view showing the alarm light device having lamps embedded in openings of the present invention.

FIG. 5 is a sectional schematic view showing the alarm light device having lamps embedded in openings of the present invention.

FIG. 6 is a perspective exploded schematic view showing another lamp module of the present invention.

FIG. 7 is an assembled schematic view showing the side lamp portion of the alarm light device having lamps embedded in openings of the present invention.

### DETAILED DESCRIPTION OF PREFERRED EMBODIMENT

The objects, the technical contents and the expected effect of the present invention will become more apparent from the detailed description of the preferred embodiments in conjunction with the accompanying drawings.

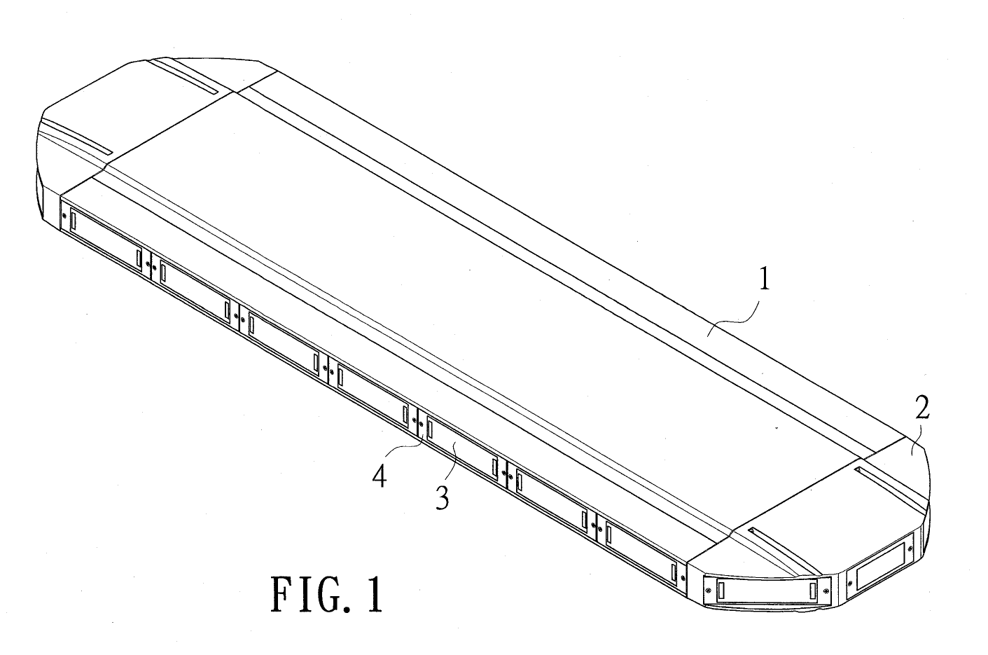

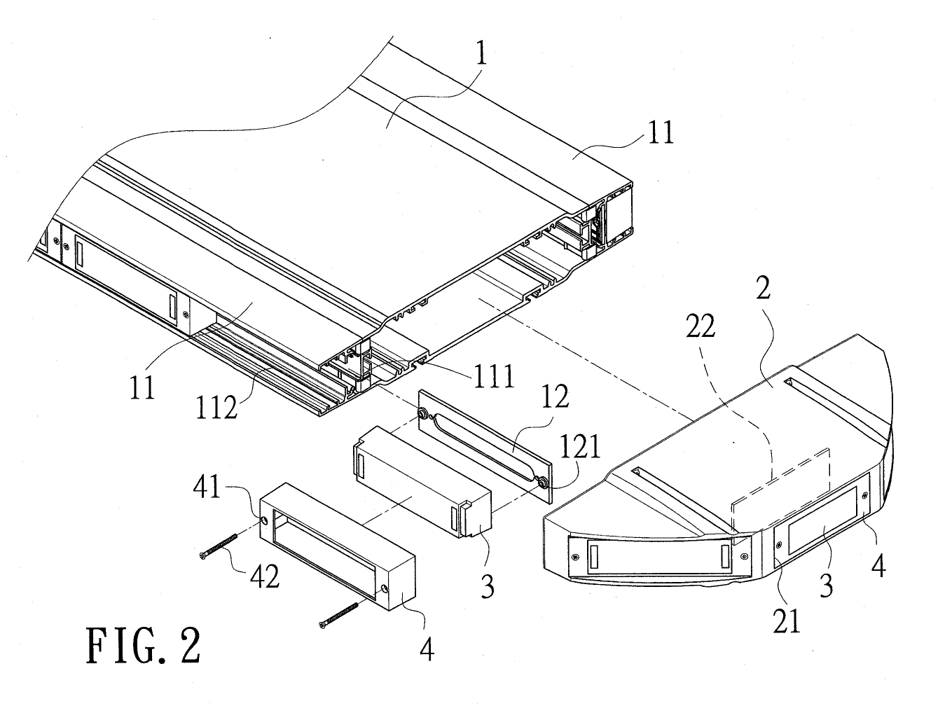

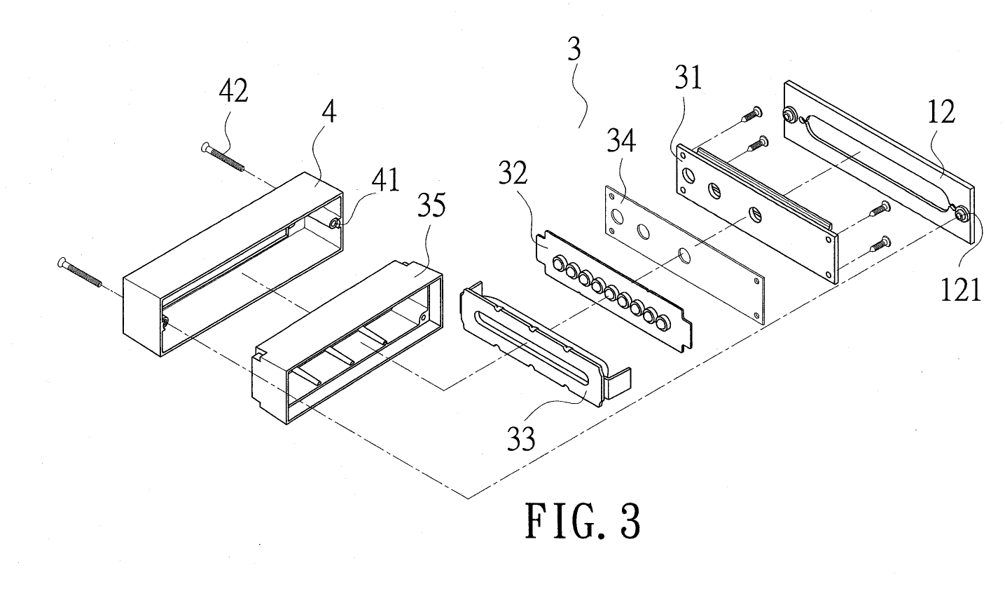

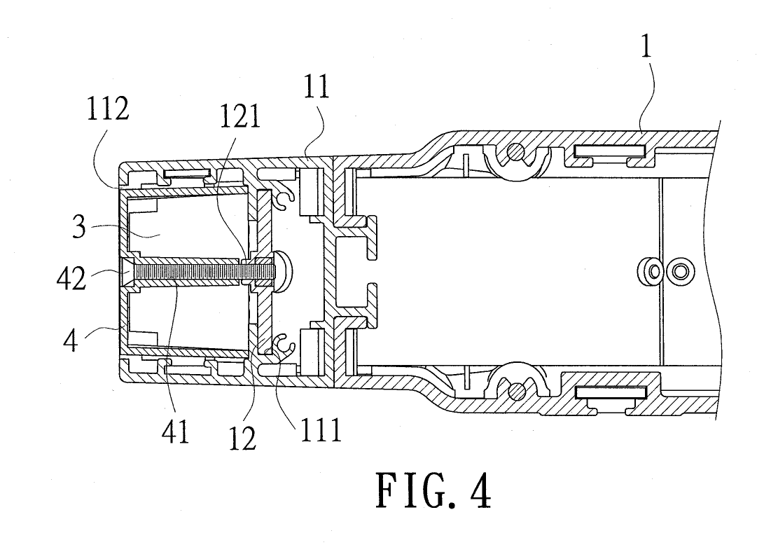

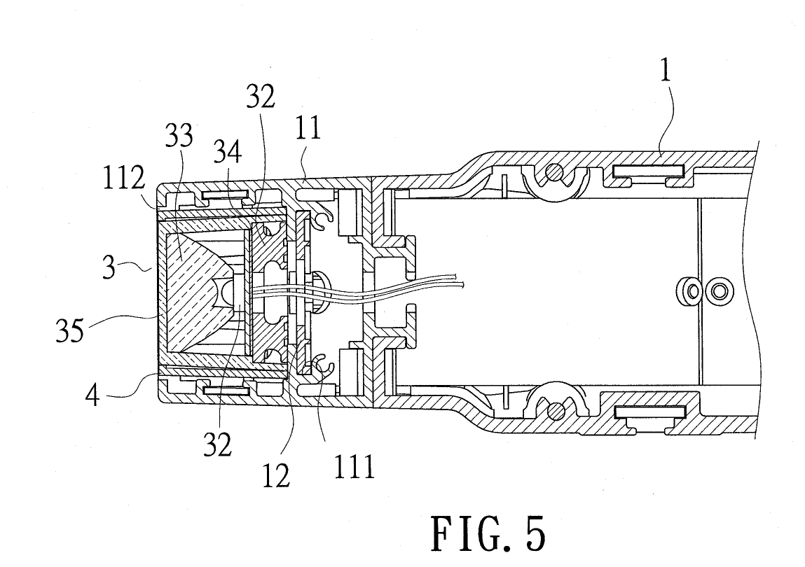

Referring to FIGS. 1 to 5, the alarm light device having lamps embedded in openings of the present invention is essentially formed by a main lamp portion (1) and two side lamp portions (2) which are coupled with the main lamp portion (1) together at both sides thereof.

The main lamp portion (1) has channeled seats (11) provided on both sides and guide rail (111) for guiding and locating base plates (12) is provided in each channeled seat (11). Opening (112) for embedding lamp modules is formed on the outside of the guide rail (111) of each channeled seat (11), into which a plurality of lamp modules (3) can be embedded. Each lamp module (3) is covered by an outer-cover (4) which is then fastened onto the base plate (12).

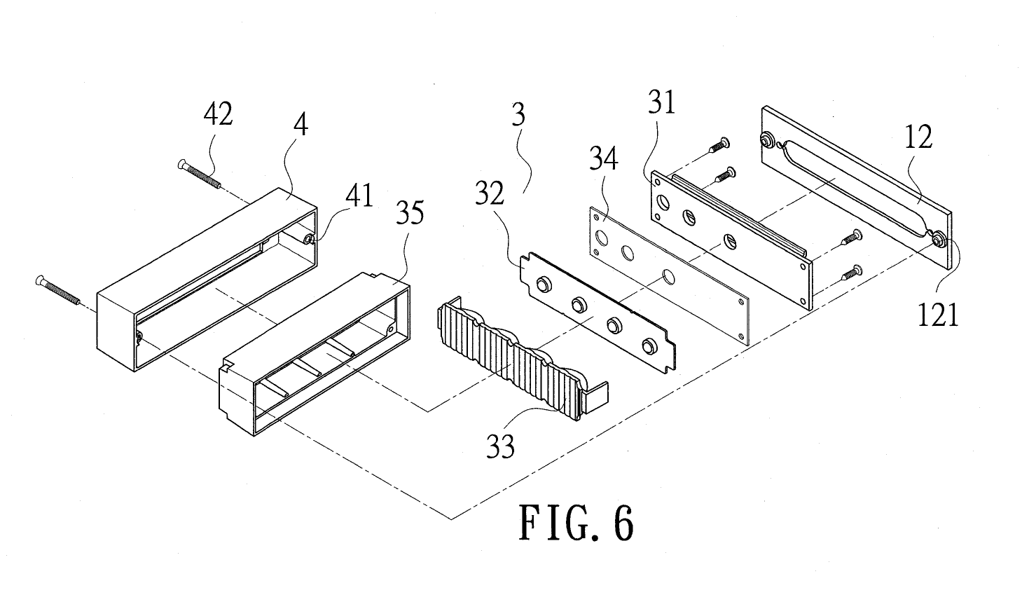

Referring to FIGS. 1 to 6, assembly process will be briefly described. Two holes (121) for fixing are provided on each base plate (12) which is inserted and positioned onto the guide rail (111) provided in each channeled seat (11) of the main lamp portion (1), and then the lamp module (3) is directly embedded from the opening (112). Each lamp module (3) is formed by a circuit substrate (31), a LED lamp unit (32) provided on the circuit substrate (31), an insulation pad (34) for overheat conduction proof interposed between the circuit substrate (31) and the LED lamp unit (32), and an optical lens (33) located before the LED lamp unit (32), in turn, the lamp module (3) is encapsulated in a housing (35) which is fastened on the circuit substrate (31). After the lamp module (3) has been embedded, an outer-cover (4) having two through holes (41) is covered thereon and is fastened by screw members (42) onto the base plate (12) such that the lamp module (3) can be fixed in position. Then, the other lamp modules (3) can be embedded therein by the same method as stated as above.

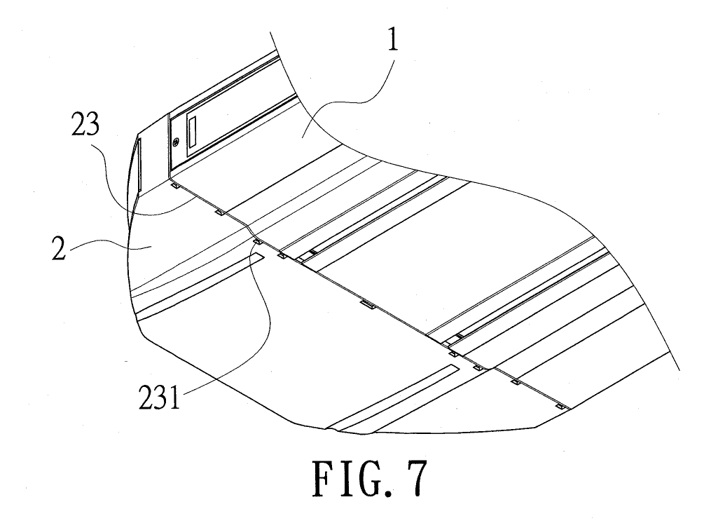

Furthermore, referring to FIG. 7, the coupling of two side lamp portions (2) and the main lamp portion (1) will be described. Gaskets (23) for combination between different materials are provided between the two side lamp portions (2) and the main lamp portion (1), and mist draining holes (231) are provided at the adhering joints between the lower peripheral edge of the two side lamp portions (2) and the gaskets (23). A number of openings (21) for embedding lamp modules (3) are provided on each side lamp portion (2), and a base plate (22) is formed within corresponding opening (21) for embedding lamp module (3) so as to provide required fastening place for the outer-cover (4) for covering the lamp module (3).

The above embodiment or drawings are not intended to restrict structural aspect or dimensions of the present invention. Appropriate variations and modifications made by the person having general knowledge in the art are still considered to be within the scope of the present invention.

Based on the foregoing, the alarm light device having lamps embedded in openings of the present invention has the advantages set forth below, when comparing with prior art.

1. The alarm light device having lamps embedded in openings of the present invention can achieve great convenience in conducting the replacement of lamp module by the design of direct assembling and disassembling the lamp module from the opening for embedding lamp module.

2. The alarm light device having lamps embedded in openings of the present invention can embed the lamp module directly from the opening for embedding lamp module by providing outer cover on the outside of the lamp module without having space for lamp cover. Hence, the effect of downsizing can be achieved.

3. The alarm light device having lamps embedded in openings of the present invention has gaskets provided between the main lamp portion and the side lamp portions and a number of mist draining holes provided between the adhering joints between the lower edges of the side lamp portions and the gaskets. Hence, excellent effect of tight combination between different materials and mist draining can be achieved.

What is claimed is:

1. An alarm light device having lamps embedded in openings, in which a main lamp portion is coupled with two side lamp portions at both sides thereof, wherein said main lamp portion has channeled seats provided at both side thereof, and guide rail for mounting base plates are provided in each channeled seat, opening for embedding lamps being formed on the outside of each guide rail, into which a plurality of lamp modules are embedded, each lamp module being covered by an outer-cover and is then fastened together onto the base plate.

2. The alarm light device having lamps embedded in openings as claimed in claim 1, wherein two holes for fixing conforms to the through holes provided on the outer-cover are provided on each said base plate, and screw members are used to fasten the lamp module together with the outer-cover on said base plate.

3. The alarm light device having lamps embedded in openings as claimed in claim 1, wherein each of said side lamps has a number of channeled openings for embedding a plurality of lamp modules, a base plate for fixing being provided within each opening for embedding lamp module so as to provide required fastening place for out-cover.

4. The alarm light device having lamps embedded in openings as claimed in claim 3, wherein gaskets are provided between said main lamp portion and said two side lamp portions.

5. The alarm light device having lamps embedded in openings as claimed in claim 4, wherein mist draining holes are provided at the adhering joints between the lower edges of said two side lamp portions and the gaskets.

6. The alarm light device having lamps embedded in openings as claimed in claim 1, wherein each said lamp module comprises a circuit substrate, a LED lamp unit provided on said circuit substrate, an insulation pad for overheat conduction proof interposed between said circuit substrate and said LED lamp unit, an optical lens unit provided before the LED lamp unit, and a housing for encapsulating which is fixed on the circuit substrate.
